(19) United States
(12) Patent Application Publication
(10) Pub. No.: US 2025/0367860 A1
(43) Pub. Date: Dec. 4, 2025

(54) INJECTION MOLDING TOOL AND INJECTION MOLDING METHOD WITH A CAVITY SEAL OF PLASTIC

(71) Applicant: SUMMERER Technologies GmbH & Co. KG, Schechen (DE)

(72) Inventor: Franz Josef Summerer, Gstadt am Chiemsee (DE)

(21) Appl. No.: 19/217,392

(22) Filed: May 23, 2025

(30) Foreign Application Priority Data
May 28, 2024 (DE) 10 2024 114 986.8
Aug. 13, 2024 (DE) 10 2024 123 129.7

(51) Int. Cl. B29C 33/00; B29C 33/42

(52) U.S. Cl. CPC B29C 33/0044; B29C 33/42

(57) ABSTRACT

An injection molding tool for manufacturing a plastic molded part having at least a plastic component has an injection molding cavity and a sealing gap of the injection molding cavity formed between opposing sealing surfaces of the injection molding tool. The injection molding tool further comprises a sealing cavity into which the sealing gap opens on its side facing away from the injection molding cavity and which is configured to be filled with a sealing plastic to seal the injection molding cavity.

### CROSS-REFERENCE TO RELATED APPLICATIONS

This application claims priority to German Patent Application 10 2024 114 986.8, filed May 28, 2024, and German Patent Application 10 2024 123 129.7, filed Aug. 13, 2024. German Patent Application 10 2024 114 986.8 and German Patent Application 10 2024 123 129.7 are incorporated herein by reference.

### TECHNICAL FIELD

The disclosure relates to an injection molding tool and an injection molding method for manufacturing a plastic molded part.

### BACKGROUND

Injection molding cavities for low-viscosity plastics, such as PUR (polyurethane), cannot be sealed metal-to-metal. With metal-to-metal cavity seals, gaps in the range between 0.01 mm and 0.05 mm occur due to dimensional accuracy tolerances and thermal effects. For higher viscosity plastics such as polycarbonate (PC), sealing gaps of this size are not a problem (i.e. sufficiently tight) or are even created specifically to vent the cavity. However, for low-viscosity plastics such as, e.g., PUR, which is thinner than water, a higher level of tightness is required, which cannot be achieved in practice with metal-to-metal sealing.

This is why injection molding cavities for low-viscosity plastics are sealed metal-to-plastic. For example, the plastic component (plastic molded part) itself is used as a sealing surface. However, this concept imposes restrictions on the shaping of the component and sometimes requires post-processing steps such as milling or similar.

A common application for low-viscosity plastics in injection molding production is PUR sealing (coating) on plastic component surfaces. Such PUR sealants create a surface-resistant high-gloss seal with an optical depth effect (so-called glazing effect). The PUR is used to protect (seal) the underlying plastic of the plastic component against environmental influences and at the same time to create the glazing effect, which is even self-healing to a certain extent (in the case of small scratches).

### SUMMARY

According to an aspect of the disclosure, an injection molding tool for manufacturing a plastic molded part including a plastic component comprises an injection molding cavity for producing the plastic component. A sealing gap of the injection molding cavity is formed between two opposing sealing surfaces of the injection molding tool. Furthermore, the injection molding tool comprises a sealing cavity into which the sealing gap opens on its side facing away from the injection molding cavity and which is configured to be filled with a sealing plastic to seal the injection molding cavity.

According to an aspect of the disclosure, a pre-chamber may be arranged in the sealing gap, which is shaped as a local expansion (enlargement) of the sealing gap.

According to an aspect of the disclosure, a method of manufacturing a plastic molded part including at least a plastic component comprises forming an injection molding cavity provided for producing the plastic component and a sealing gap of the injection molding cavity formed between two opposing sealing surfaces of the injection molding tool, wherein the sealing gap opens into a sealing cavity at its side facing away from the injection molding cavity. To seal the sealing gap, the sealing cavity is filled with a sealing plastic. The injection molding cavity is filled with the plastic component, which finds an injection molding cavity of sufficient tightness due to the sealing plastic.

According to a further aspect of the disclosure, a method of manufacturing a plastic molded part including at least a plastic component comprises forming an injection molding cavity provided for producing the plastic component and a sealing gap of the injection molding cavity formed between two opposing sealing surfaces of the injection molding tool, wherein the sealing gap opens into a sealing cavity on its side facing away from the injection molding cavity. A pre-chamber is arranged in the sealing gap, which is shaped as a local expansion of the sealing gap. To seal the sealing gap, the sealing cavity is filled with a sealing plastic. The injection molding cavity is filled with the plastic component, which finds an injection molding cavity of sufficient tightness due to the sealing plastic in the sealing gap. The pre-chamber is at least partially filled with the plastic of the plastic component. This locally increases the mechanical stability of a burr at the plastic molded part that is created when the injection molding cavity is filled.

### BRIEF DESCRIPTION OF THE DRAWINGS

The elements of the drawings are at least partly but not necessarily to scale relative to each other. Relative dimensions (greater than, less than, equal to, etc.) can be derived from the drawings. Like reference numerals designate corresponding similar parts. The features of the various illustrated examples can be combined unless they exclude each other and/or can be selectively omitted if not described to be necessarily required. Various examples are depicted in the drawings and are exemplarily detailed in the description which follows.

FIG. 1 is a schematic representation of an example of a plastic molded part with seal in plan view and in sectional view (sectional line X-X).

FIGS. 2 to 5 are sectional views of an example of a tool and exemplary method steps for manufacturing a base molded part.

FIGS. 6 to 9 are sectional views of an example of a tool and exemplary method steps for manufacturing a plastic molded part containing at least a plastic component.

FIGS. 10A and 10B are examples of a sealing gap in sectional view.

FIG. 10C is a sectional view of an example of a sealing gap with pre-chamber.

FIG. 11 is a schematic representation of an example of a plastic molded part with seal in plan view and in sectional view (sectional line X-X).

FIGS. 12 to 13 show a sectional view of the tool of FIGS. 6 to 9 as well as further exemplary method steps for manufacturing the plastic molded part.

### DETAILED DESCRIPTION

As used in this specification, the terms “connected” or “coupled” or similar terms are not meant to mean that the elements are directly contacted together; intervening elements may be provided between the “connected” or “coupled” elements, respectively. However, in accordance with the disclosure, the above-mentioned and similar terms may, optionally, also have the specific meaning that the elements are directly contacted together, i.e. that no intervening elements are provided between the “connected” or “coupled” elements, respectively.

Further, the words “over” or “beneath” with regard to a part, element or material layer formed or located or arranged “over” or “beneath” a surface may be used herein to mean that the part, element or material layer be located (e.g. placed, formed, arranged, deposited, etc.) “directly on” or “directly under”, e.g. in direct contact with, the implied surface. The word “over” or “beneath” used with regard to a part, element or material layer formed or located or arranged “over” or “beneath” a surface may, however, either be used herein to mean that the part, element or material layer be located (e.g. placed, formed, arranged, deposited, etc.) “indirectly on” or “indirectly under” the implied surface, with one or more additional parts, elements or layers being arranged between the implied surface and the part, element or material layer.

Sealing difficulties in injection molding tools are often caused by edge areas of the plastic molded part, especially if these are undercut.

Among others, a problem underlying the disclosure may be seen in the provision of an injection molding tool and a method for manufacturing a plastic molded part which make it possible to easily produce plastic molded parts which contain a plastic component made of, in the plasticized state, thin plastic, for example. In particular, a higher design variability of the plastic molded part and a process-reliable manufacturing method may be desired.

According to the disclosure, the sealing gap in the injection molding tool is closed by sealing plastic. This ensures that the (in its plastic state) low-viscosity plastic injected into the injection molding cavity cannot escape through the sealing gap (which is formed by the two opposing sealing surfaces of the injection molding tool). This makes it possible to use conventional metal-to-metal sealing concepts for the injection molding cavity, such as those used for sealing plastics with a higher viscosity in the plastic state (e.g. PC (polycarbonate)). In particular, no metal-to-plastic seal is required adjacent to a contour surface of the injection molding cavity.

In other words, the sealing gap may be sealed using a specially designed sealing plastic. The sealing plastic is filled into the sealing cavity and thereby seals the sealing gap, e.g., at a suitable point along the course of the sealing gap.

For example, the sealing gap can be formed by or comprise a cutting-against-cutting pairing or a cutting-against-sealing surface pairing or a pairing of two parallel sealing surfaces. In the first two cases, a tear-off line is specifically created for the seal, while in the second case, very thin burrs (flashes) can be realized on the plastic component.

A pre-chamber may be arranged in the sealing gap. The pre-chamber may be shaped as a local expansion of the sealing gap, ensuring that a sealing burr connected to the plastic component, which is created in the sealing gap, is locally thickened and therefore has greater stability in this area. This makes it possible to separate the sealing burr from the plastic component at a defined separating line. This can avoid the risk of contamination of the injection molding cavity by residues of the sealing burr and may make reworking of the plastic molded part (burr removal) unnecessary.

A first section of the sealing gap between the pre-chamber and the sealing cavity may be configured to provide a partial filling of the pre-chamber with sealing plastic when filling the sealing cavity with sealing plastic. This results in an increased contact surface between the plastic of the plastic component and the sealing plastic. This has the effect that the plastic of the plastic component (e.g. PUR) is connected to the sealing plastic in a mechanically stable manner and remains securely attached to the sealing plastic when the sealing plastic is removed (e.g., during removal of the plastic component from the injection molding cavity).

A second section of the sealing gap between the injection molding cavity and the pre-chamber can have a constriction that defines a separating line for the plastic of the plastic component. In this way, the location or course of the separating line can be defined. In particular, the constriction can be located directly at the mouth of the second section of the sealing gap in the injection molding cavity, creating a (virtually) burr-free seal of the injection molding cavity.

For example, the constriction can be formed by tapering the second section of the sealing gap, e.g. in the form of a cutting-against-cutting pairing or a cutting-against-sealing surface pairing. This specifically creates a separation line for the seal. The second section of the sealing gap can taper from the pre-chamber towards the constriction.

For example, one of the sealing surfaces delimiting the sealing gap can be present on a mold plate or a mold plate insert with a contour surface of the injection molding cavity.

It is also possible for one of the two sealing surfaces to be provided on a slide, in particular a transverse or oblique slide, which has a contour surface of the injection molding cavity. A slide makes it possible to realize undercut contours of the injection molding cavity.

If the plastic molded part is produced using an injection compression molding method, at least one of the two sealing surfaces can be present on a sealing strip (embossing frame) of the injection molding tool.

The sealing cavity or, if present, the pre-chamber can be arranged directly adjacent to the injection molding cavity or at a certain distance from the injection molding cavity. For example, in the second case, a distance measured along the sealing gap between the injection molding cavity and the sealing cavity (or, if present, the pre-chamber) can be between 0.05 mm and 1 mm, in particular between 0.2 mm and 0.4 mm or 0.5 mm.

The sealing cavity can, for example, have a cross-sectional height of between 2 mm and 7 mm, e.g. between 2 mm and 5 mm. Larger cross-sectional heights are also possible, but lead to increased material loss. The cross-sectional height of the sealing cavity is considerably greater than the width of the sealing gap. A certain cross-sectional height is required in order to fill the sealing cavity completely and sufficiently quickly and reliably with the sealing plastic.

The pre-chamber (if present) can have a cross-sectional height of between 0.1 mm and 2 mm, for example, although larger cross-sectional heights are also possible.

For example, the sealing cavity can partially or completely surround the injection molding cavity in the shape of a tube.

The injection molding tool can also include a plastic feed connected to the sealing cavity. The sealing plastic is fed into the sealing cavity in a plastic state by means of the plastic feed.

The sealing surfaces may abut each other (e.g. at the constriction). However, it is also possible to specifically form a small (minimal) distance between the sealing surfaces, as the sealing of the injection molding cavity is achieved by the sealing plastic in any case (i.e. both with abutting and slightly spaced sealing surfaces).

The sealing gap can have a tightness that would seal the injection molding cavity when filled with polycarbonate.

However, the tightness of the sealing gap may be too low for filling the injection molding cavity with PUR, for example (so-called PUR flooding). This means, for example, that the sealing gap may have a tightness that does not seal the injection molding cavity when filled with PUR. In particular, the sealing gap may not be airtight (which would be necessary with PUR flooding).

The injection molding cavity can have a flat shape with an edge bending of more than 90°, and the sealing gap of the injection molding cavity can be arranged at or in front of the apex of the bending. This allows an undercut plastic component to be produced. For example, the sealing gap can be arranged less than, for example, 10° or 20° in front of the apex of the bending.

The plastic molded part can be multi-component. For example, the plastic molded part can have a base molded part and the plastic component. The injection molding cavity of the injection molding tool can be designed in such a way that the plastic component forms a surface coating of the base molded part. The plastic component (e.g. PUR sealant) can also seal edge areas of the plastic molded part, even if an edge bending of the base molded part to be sealed is 90° or more.

The method of manufacturing a plastic molded part may comprise the manufacturing of a further plastic molded part after the plastic molded part has been removed from the injection molding cavity. In this case, the method described is carried out again, but instead of filling the sealing cavity, a seal formed by the sealing plastic during the manufacturing of the (now removed) plastic molded part is left in the sealing cavity and used as a seal in the manufacturing of the further plastic molded part.

In other words, a seal formed in the sealing cavity can be used several times, if applicable. This makes it possible to save on sealing plastic material. Depending on the process control and the geometry of the plastic molded part, however, it may be necessary to form a new seal from sealing plastic after a certain number of injection molding cycles, as it is to be expected that the sealing effect of the seal will diminish over time due to the temperature cycles and shrinkage.

When filling the sealing cavity, the pre-chamber can optionally be partially filled with the sealing plastic.

The viscosity of the sealing plastic in the plastic (liquid) state can be greater than the viscosity of the plastic of the plastic component in the plastic (liquid) state.

The viscosity of the plastic of the plastic component can be so low in the plastic state that the plastic of the plastic component would escape through the sealing gap into the sealing cavity if the sealing cavity were not filled.

The viscosity of the sealing plastic can be so high in the plastic state that the sealing plastic (in the plastic state) does not pass from the sealing cavity through the sealing gap into the injection molding cavity. This prevents a defect from occurring in the plastic component. Optionally, if the pre-chamber is present, the sealing plastic can, for example, reach the pre-chamber (in order to partially fill it).

The plastic molded part can have a base molded part and the plastic component, whereby the plastic component is injected onto the base molded part as a surface coating by filling the injection molding cavity. In this case, it is possible to produce surface coatings of the base molded part which, for example, run around an edge area of the base molded part in a bending greater than 90°.

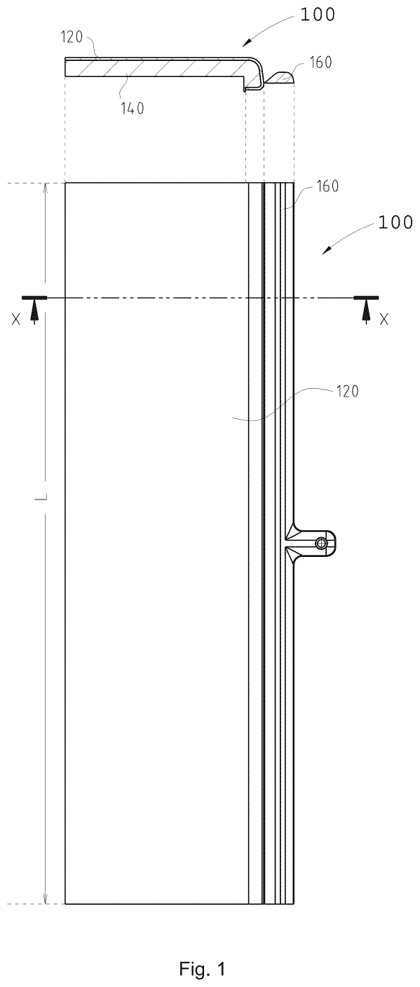

Referring to FIG. 1, a schematic representation of an example of a plastic molded part 100 is shown. The plastic molded part 100 has a plastic component 120. It may—as in the example shown here-comprise further plastic components. For example, the plastic molded part 100 includes a base molded part 140. The plastic component 120 can, for example, be molded onto the base molded part 140 as a surface coating.

Examples of the disclosure are explained below with reference to a plastic molded part 100 which, in addition to the plastic component 120, contains the base molded part 140. However, the base molded part 140 is optional. This means, for example, that the plastic molded part 100 can also comprise the plastic component 120 alone.

In the following examples, the base molded part 140 is also made of plastic. However, it is also possible that the base molded part 140 is made of a different material, i.e. is not a plastic molded part manufactured by injection molding.

The plastic molded part 100 (and in particular the plastic component 120) can be a flat part. The thickness of the base molded part 140 can be, for example, only a few millimeters (for example, less than 1 cm). The thickness of the plastic component 120 can be between 0.1 mm and 1 mm as a coating (e.g. in the example shown here).

The plastic molded part 100 may be or include, for example, a glazing part with a surface coating (plastic component 120) or, for example, a transparent pane with a surface seal (plastic component 120). For example, the plastic molded part 100 may be a vehicle trim component (e.g. fender, etc.).

The plastic component 120 can largely or completely cover the base molded part 140 (if present) on an outer surface. In particular, the plastic component 120 can also cover an edge section of the base molded part 140 that is designed as a bending. In this case, the plastic component 120 can have an edge-side bending of more than 90°. For example, this bending can be U-shaped.

If the plastic molded part 100 is realized without a base molded part 140, the plastic molded part 100 can be an undercut plastic molded part 100 according to the course of the plastic component 120.

The plastic molded part 100 can have a large surface area and, for example, a length L equal to or greater or less than 0.1 m, 0.2 m, 0.4 m, 0.6 m, 0.8 m, 1 m or 2 m.

The plastic component 120 of the plastic molded part 100 can, for example, be connected to a seal 160 via a web 130 (not visible in FIG. 1). As will be described in more detail below, the seal 160 serves to seal an injection molding cavity, in which the plastic component 120 is produced, in a sealing gap.

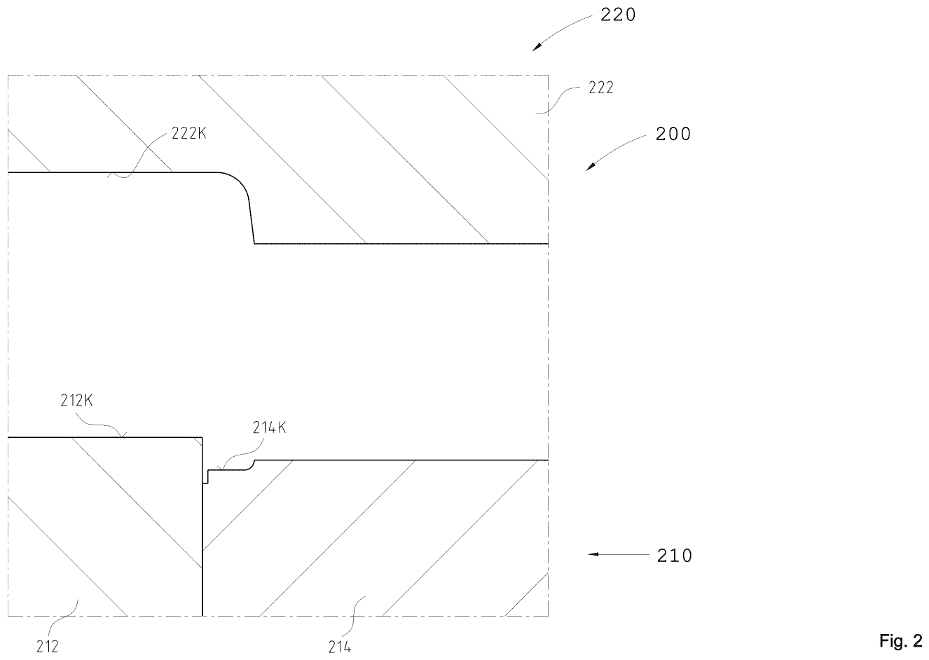

FIGS. 2 to 5 show a tool 200 and manufacturing steps that can be used to manufacture the base molded part 140. As already mentioned, the base molded part 140 is optional, so that the tool parts and manufacturing steps shown in FIGS. 2 to 5 can also be omitted.

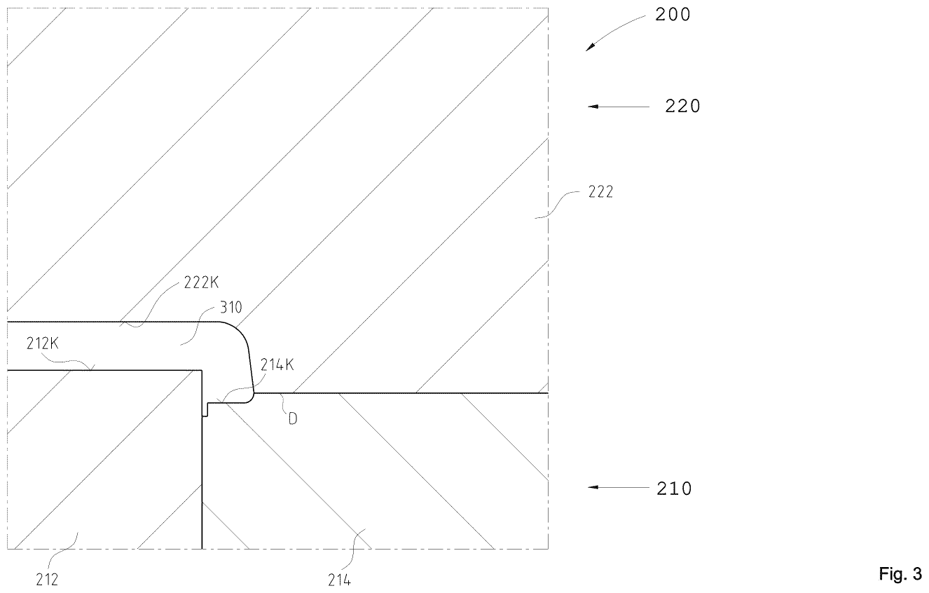

A tool 200 can be used to manufacture the base molded part 140, which is shown in FIG. 2 in the open state and in FIG. 3 in the closed state. The tool 200 can have a first mold half 210 and a second mold half 220. The first mold half 210 can, for example, include a mold plate or a mold plate insert 212 and a sealing strip 214. Both the mold plate or mold plate insert 212 and the sealing strip 214 can have contour surfaces 212K or 214K of an injection molding cavity 310, which is formed between the first and second mold halves 210, 220 when the mold is closed (see FIG. 3). The sealing strip 214 may be displaceably mounted in the first mold half 210 (e.g., in a direction parallel to the closing direction).

In the case of a compression injection molding tool, an embossing strip (e.g. embossing frame) can be used as the sealing strip 214. In other words, the sealing strips of the tool can be equipped with the additional functionality described above for providing an edge seal (e.g., an all-around sealing of a circumferential edge of the plastic molded part).

The second mold half 220 may also be formed from or comprise a mold plate or mold plate insert 222. The second mold half 220 also provides a contour surface 222K for manufacturing the base molded part 140.

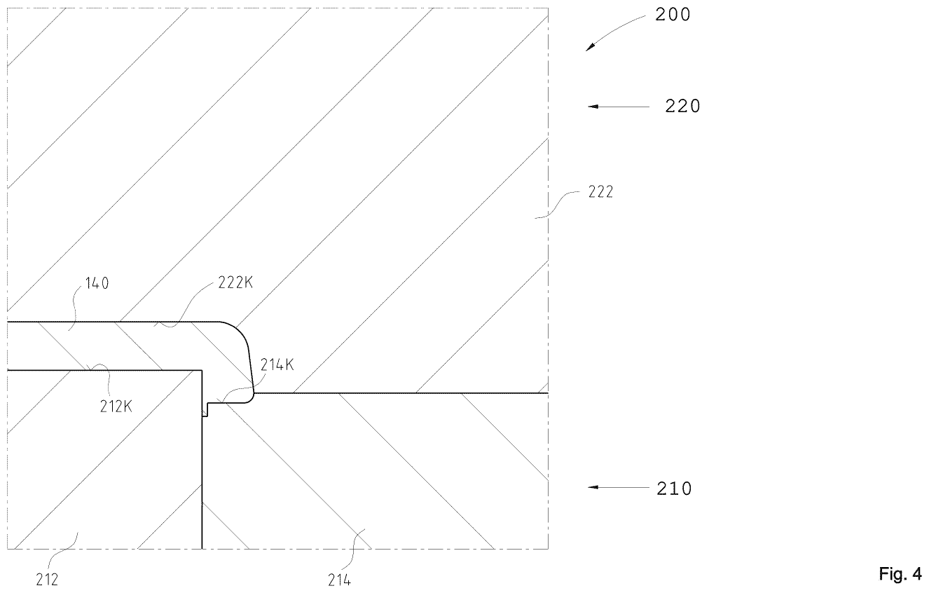

According to FIG. 4, the injection molding cavity 310 is filled with a plastic that forms the base molded part 140. For example, this may be polycarbonate (PC). FIG. 4 shows an edge section of the base molded part 140, which is produced in the mold 200.

A sealing gap D is located between the first mold half 210 and the second mold half 220 in the closed state of the mold 200. The sealing gap D opens into the injection molding cavity 310. When the injection molding cavity 310 is filled with the plastic used for the base molded part 140, this sealing gap D has the tightness required for injection molding production. The sealing gap D extends, for example, in the parting plane of the tool 200 and can be realized metal-to-metal.

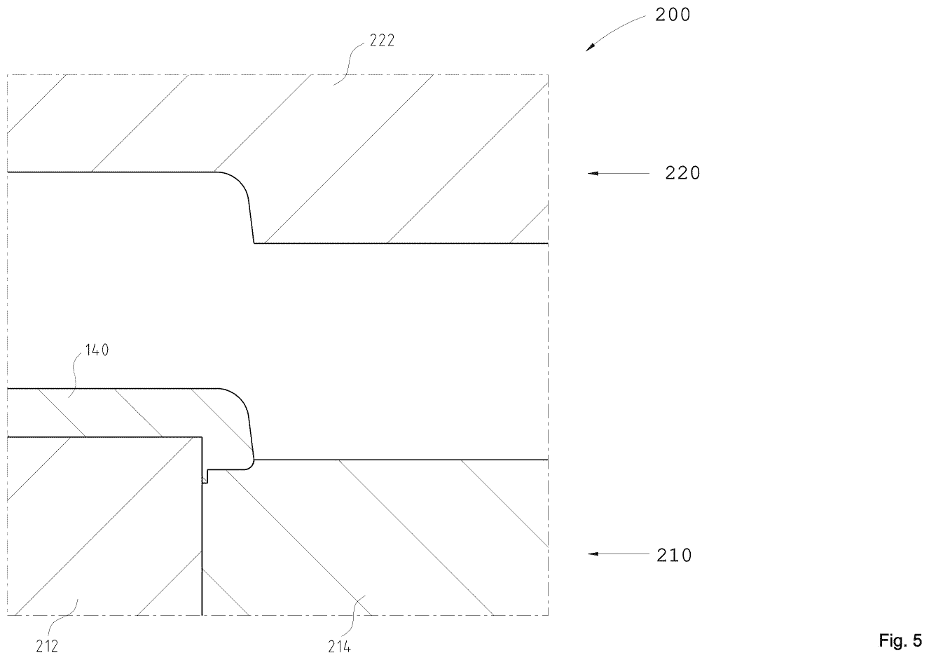

After solidification of the base molded part 140, the tool 200 is opened, see FIG. 5. The base molded part 140 can remain on the first mold half 210, for example.

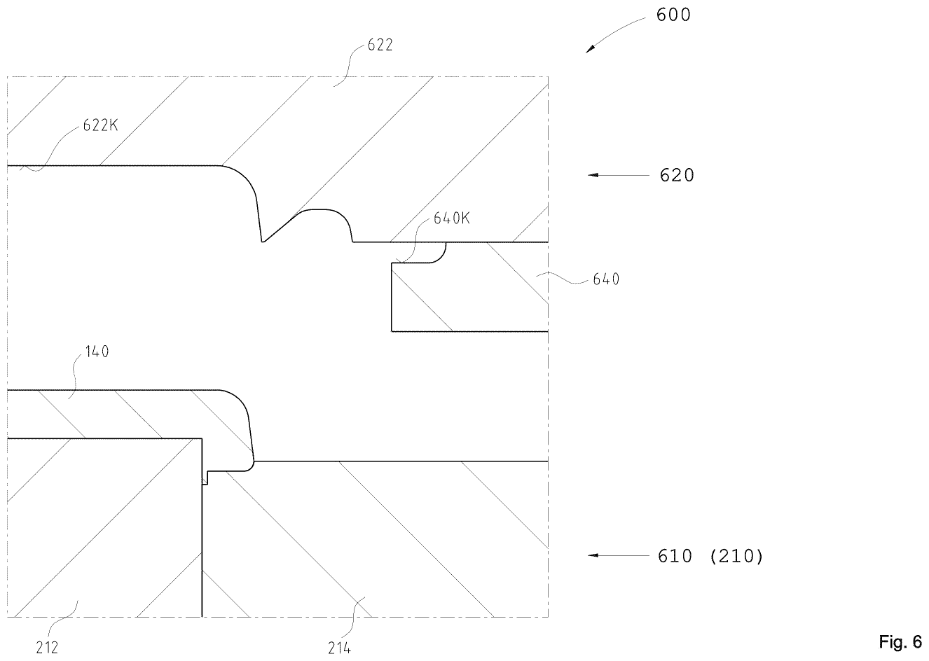

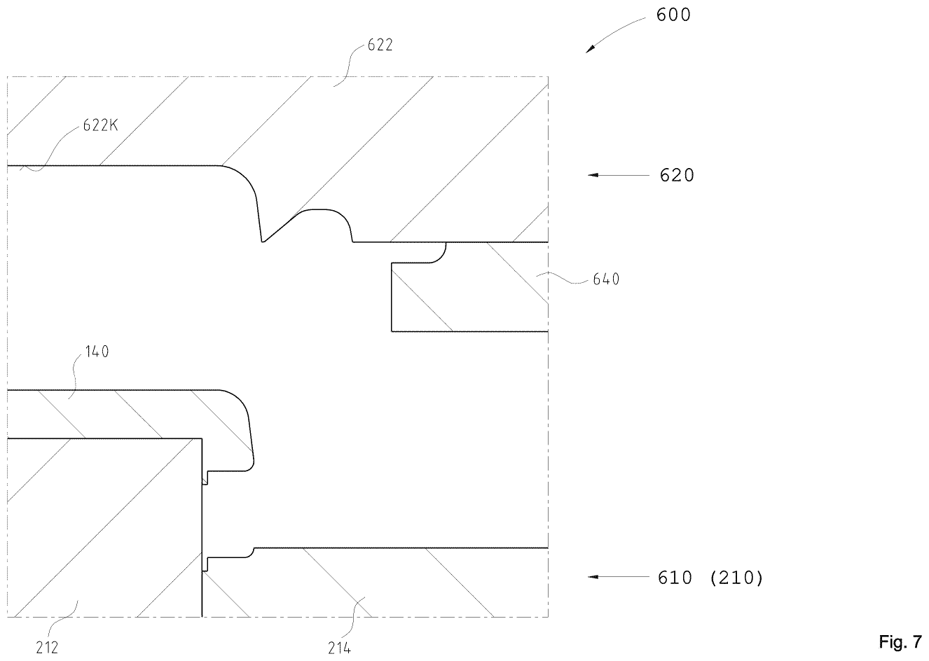

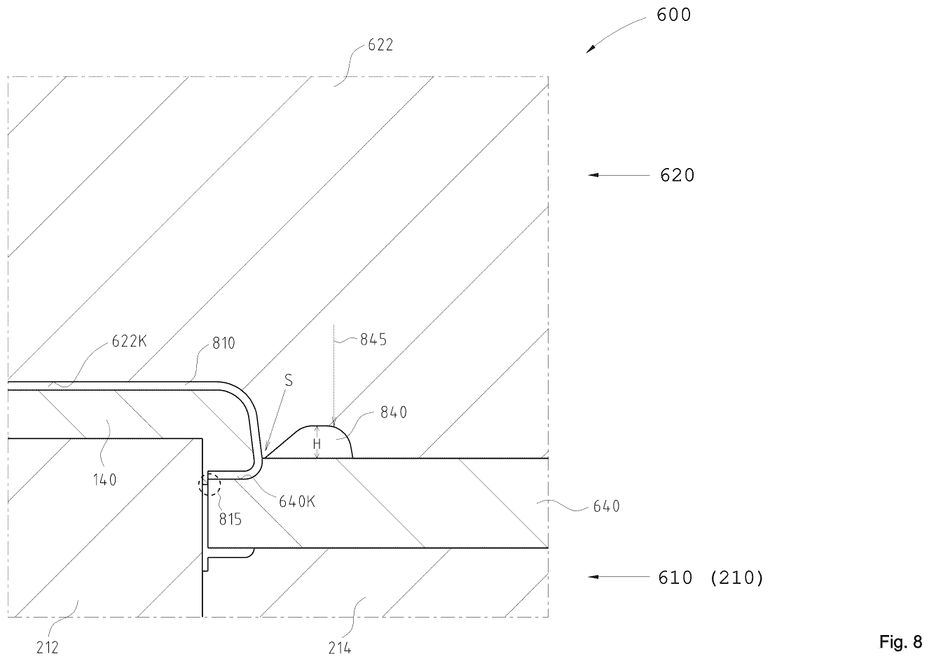

FIG. 6 shows the (optional) base molded part 140 in an injection molding tool 600. The injection molding tool 600 is shown in the open state in FIGS. 6 and 7 and in the closed state in FIG. 8.

The injection molding tool 600 has a first mold half 610 and a second mold half 620. The first mold half 610 can, for example, be identical to the first mold half 210 of the mold 200. To avoid repetition, reference is made to the above description.

The second mold half 620 can have a mold plate or a mold plate insert 622. The mold plate or mold plate insert 622 provides a contour surface 622K for manufacturing the plastic molded part 100, or more precisely the plastic component 120 thereof. The contour surface 622K may, for example, extend parallel to or at a constant distance from the surface of the base molded part 140.

As can be seen in FIG. 7, the sealing strip 214 can be moved downwards in the first mold half 210. This exposes the outer contour of the base molded part 140 in the area of the bending.

FIG. 8 shows that an injection molding cavity 810 is created when the injection molding tool 600 is closed. The injection molding cavity 810 extends between the contour surface 622K and, for example, a surface of the base molded part 140. If the plastic molded part 100 to be produced does not have a base molded part 140, the injection molding cavity 810 extends between the contour surface 622K and a contour surface of the first mold half 610 (which may, for example, be designed in accordance with the surface of the base molded part 140).

The second mold half 620 can be equipped with a slide 640. The slide 640 can be realized as a transverse or oblique slide, i.e. it can be displaceable in a direction transverse or oblique to the closing direction of the injection molding tool 600. Alternatively, the slide 640 may be provided on the first mold half 610.

FIG. 8 illustrates that after the injection molding tool 600 is closed, the slide 640 is moved to an end position. The slide 640 has a contour surface 640K of the injection molding cavity 810. In the closed state of the injection molding tool 600 with the slide 640 advanced into its end position, the contour surface 622K can be flush (e.g. without steps and/or kinks) with the contour surface 640K of the slide 640.

At this point, a sealing gap S occurs between the slide 640 and the mold plate or the mold plate insert 622, which is connected to the injection molding cavity 810. The sealing gap S adjoins contour surfaces of the injection molding cavity 810—here, for example, the contour surface 640K of the slide 640 and the contour surface 622K of the mold plate or the mold plate insert 622. However, the sealing gap S can also extend between other mold parts. For example, the sealing gap S can run in the parting plane of the injection molding tool 600 (not shown).

The sealing gap S is formed by two opposing sealing surfaces of the injection molding tool. The sealing surfaces can abut each other or can be spaced apart at a very small distance (e.g. 1/100 mm to 3/100 mm). The sealing gap S can be realized metal-to-metal.

The injection molding tool 600 also includes a sealing cavity 840. The sealing gap S opens into the sealing cavity 840 on its side facing away from the injection molding cavity 810. The sealing cavity 840 is configured to be filled with a sealing plastic to seal the injection molding cavity 810. The sealing cavity 840 may, for example, have a rounded shape in some areas.

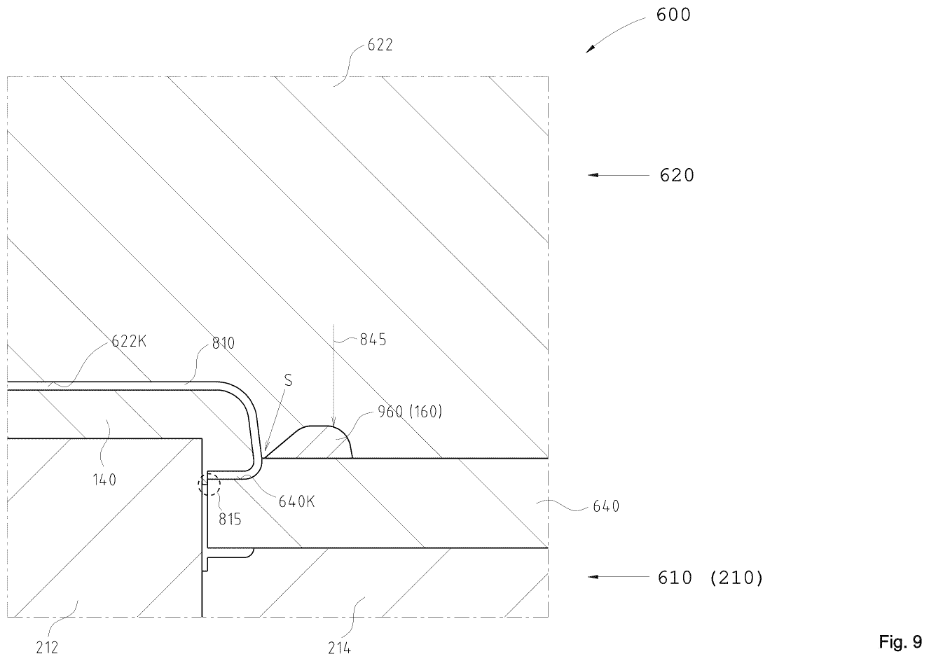

FIG. 9 shows the sealing cavity 840 after filling with the sealing plastic 960. The sealing plastic 960 realizes the seal 160 shown in FIG. 1.

The sealing plastic 960 (seal 160) prevents low-viscosity plastic from the plastic component escaping from the injection molding cavity through the sealing gap S when the injection molding cavity is filled.

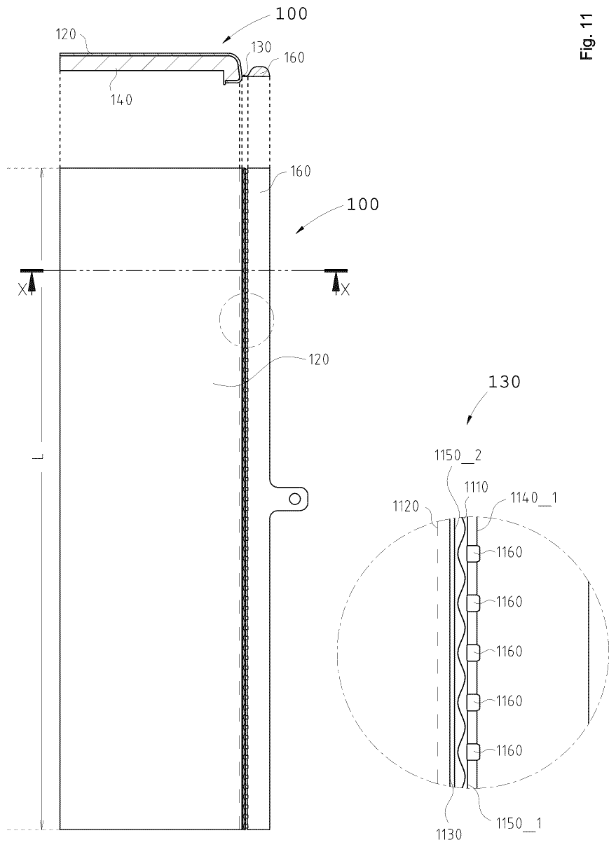

The sealing plastic 960 is introduced into the sealing cavity 840 via a plastic feed 845 in communication with the sealing cavity 840. The plastic feed 845 is shown schematically in FIGS. 8 to 10 and 12 to 13 (and shown in FIGS. 1 and 11 as a nose-shaped extension of the seal 160).

The sealing cavity 840 and thus the sealing plastic 960 (seal 160) with complementary shaping can have a (maximum) cross-sectional height H between, for example, 2 mm and 7 mm, in particular 2 mm and 5 mm. The smaller the cross-sectional height H, the less material is wasted to produce the seal 160. On the other hand, a sufficient cross-sectional height H must be chosen for fast and reliable filling of the sealing cavity 840.

The manufacturing of the seal 160 in the mold 600 produces a very high level of tightness of the seal 160, since the sealing plastic 960 fills the sealing cavity 840 completely and accurately.

The sealing cavity 840 can partially or completely surround the injection molding cavity 810 in the form of a tube. Since large-area plastic molded parts 100 can be produced, the length of the sealing cavity 840 can be, for example, equal to or more than 20 cm, 50 cm, 1 m, 2 m, 3 m, 4 m, 5 m or 6 m.

A further sealing of the injection molding cavity 810 takes place in the example shown here, for example in the area 815. This sealing takes place metal-to-plastic (namely the plastic of the base molded part 140) and thus fulfills the requirement for tightness.

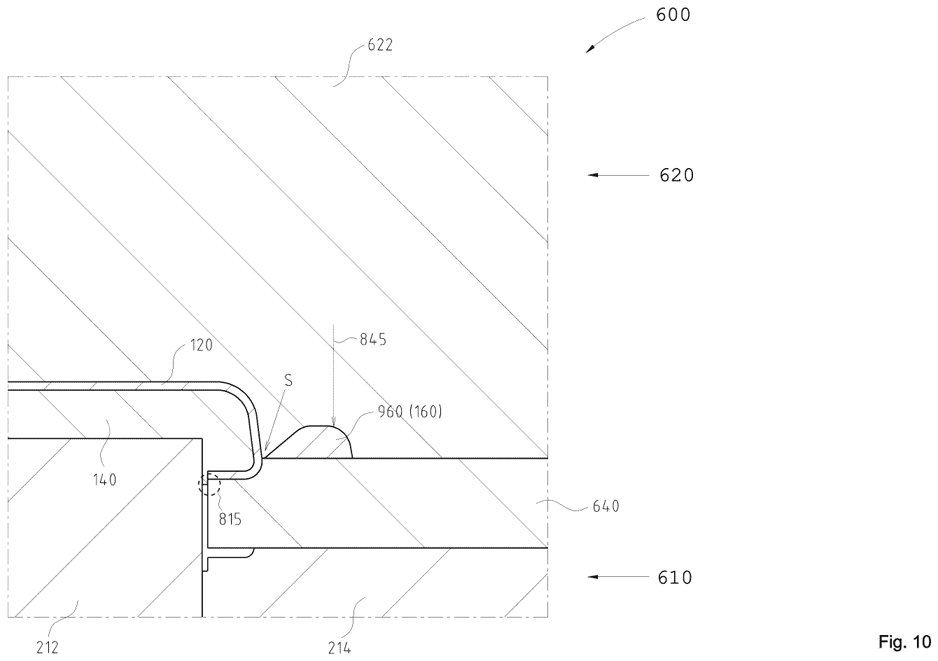

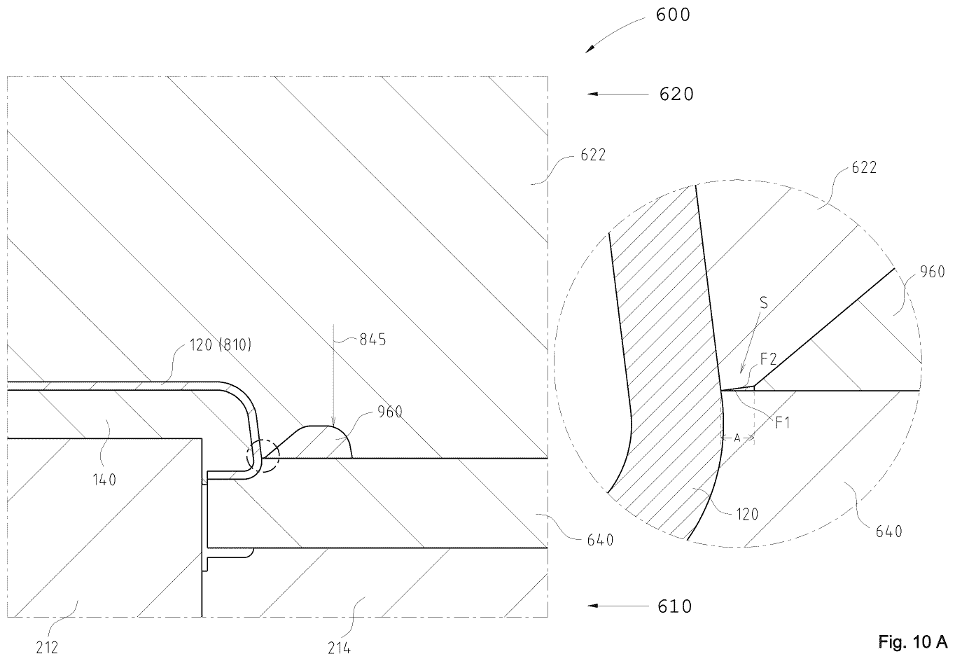

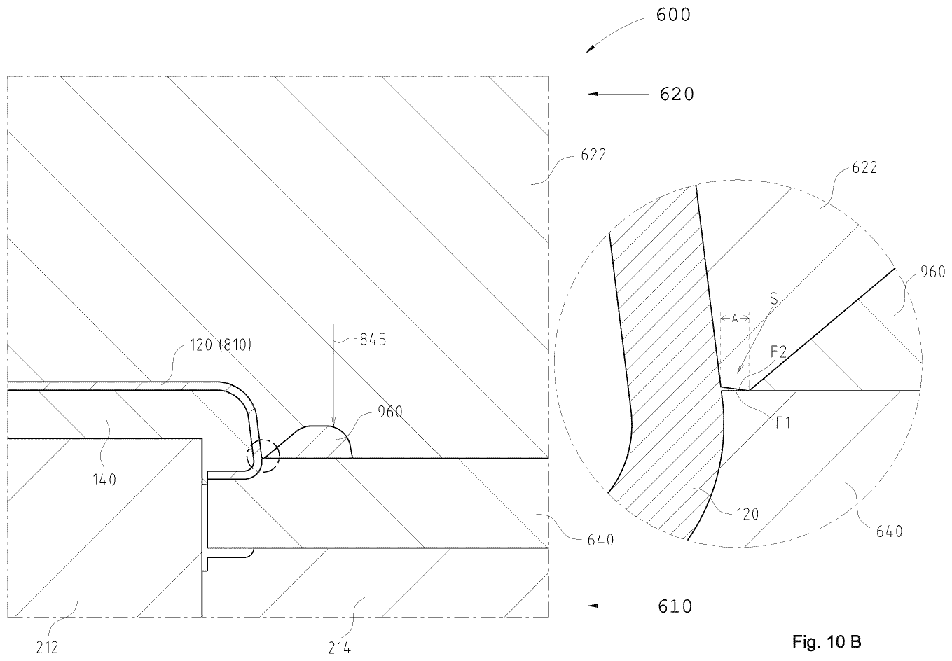

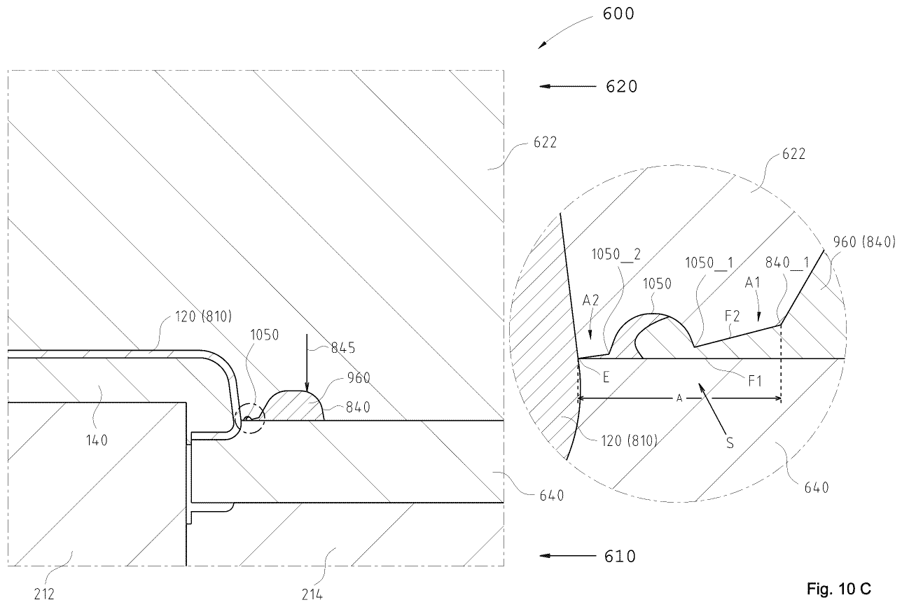

FIGS. 10A and 10B show the injection molding tool 600 after the injection molding cavity 810 has been filled with the plastic component 120. Filling with a plastic component of low viscosity in the plastic state (e.g. PUR, which is thinner than water) is also referred to as flooding. The sealing plastic 960 (seal 160) ensures that neither air nor the low-viscosity plastic component can escape from the injection molding cavity 810 through the sealing gap S.

FIGS. 10A and 10B show exemplary implementations of the sealing gap S.

The sealing gap S is defined by two sealing surfaces F1 and F2, which lie opposite each other and touch each other in a planar or at least linear manner. The sealing surfaces F1, F2 are located on opposing tool parts, e.g. metal parts, which in the present example are realized as a slide 640 or as a mold plate or mold plate insert 622 of the second mold half 620. However, it is also structurally possible to provide the sealing gap S between other mold parts in the injection molding tool 600.

According to a first example (not shown), the two sealing surfaces F1, F2 can run parallel to each other and thus abut flatly against each other.

According to a second example, the two sealing surfaces F1, F2 can be oriented at an (e.g. flat) angle to each other. FIG. 10A shows a first variant in which the sealing gap S widens towards the sealing cavity 840 (which is filled with the sealing plastic 960). FIG. 10B shows a second variant in which the sealing gap S widens towards the injection molding cavity 810 (which is filled with the plastic component 120).

FIG. 10C shows another example of the injection molding tool 600 after the injection molding cavity 810 has been filled with the plastic component 120. In this example, the sealing gap S extending between the injection molding cavity 810 and the sealing cavity 840 comprises a pre-chamber 1050.

The pre-chamber 1050 arranged in the sealing gap S serves to increase the mechanical stability of a connection (web 130) between the sealing cavity 840 and the plastic (burr or flash) of the plastic component 120 emerging from the injection molding cavity 810 in a locally defined manner and thus to facilitate or enable a safe and defined separation of the seal 160 and the burr from the plastic molded part 100.

In particular, this enables burr-free separation of the plastic molded part 100 from the seal 160 in a reliable process. The pre-chamber 1050 serves to increase the wall thickness of the burr and thus the inherent strength of the burr. This is advantageous to ensure that the burr is removed 100% in its entirety with the seal 160 and that no thin residual pieces of the burr contaminate the injection molding cavity 810.

That is, in the case of FIG. 10C, the burr is defined by the size of the pre-chamber 1050 and can be several millimeters or centimeters thick and wide. These dimensions of the pre-chamber 1050 are possible because a second constriction 1050_1 is present, which keeps the sealing plastic 960 from completely filling the pre-chamber 1050, for example. The plastic that exits the injection molding cavity 810 from the constriction (sealing edge) E is referred to as the burr.

A further effect of the pre-chamber 1050 may be that it can be used as an overflow for the plastic of the plastic component 120. In particular in PUR flooding, overflows are used to remove air-contaminated plastic (i.e. foam-like plastic containing air bubbles) from the injection molding cavity 810. For this purpose, for example, a large pre-chamber volume can be chosen in order to enable a large overflow volume of the plastic and thus enable good venting of the plastic filling at the edge zones, in particular corners, of the plastic molded part 100.

It may be provided that the pre-chamber 1050 is only partially filled (i.e., only in a partial volume of the pre-chamber 1050) with the plastic of the plastic component. This results in an enlarged contact surface between the plastic (burr) of the plastic component 120 emerging from the injection molding cavity 810 and the sealing plastic 960 when the injection molding cavity 810 is filled. This has the effect that the emerged plastic (burr) of the plastic component 120 is mechanically stably bonded to the sealing plastic 960 and remains on the seal 160 when the seal 160 is removed (e.g. by removing the plastic molded part from the injection molding tool).

As an alternative or in addition to improved burr removal, partial filling of the pre-chamber 1050 also enables venting of the injection molding cavity 810, as described above.

In order to achieve, for example, a desired partial filling of the pre-chamber 1050 with sealing plastic 960, the sealing gap S in a first section A1 between the sealing cavity 840 and the pre-chamber 1050 (i.e., between the transition 840_1 from the sealing cavity 840 into the first section A1 and the first boundary 1050_1 of the pre-chamber 1050) can be designed such that it creates a swelling, i.e., holding pressure-free partial filling of the pre-chamber 1050. This can be achieved, for example, by the gap width of this section being approximately 1/10 mm. This ensures that in the disclosed 2-chamber system (pre-chamber 1050 and sealing cavity 840), the pre-chamber 1050 is used for the secure mechanical connection between the plastic of the plastic component 120 and the sealing plastic, while the (larger) chamber (sealing cavity 840) is used to distribute the sealing plastic 960 around the plastic molded part 100.

A second section A2 of the sealing gap S between the injection molding cavity 810 and the pre-chamber 1050 (more precisely, the second boundary 1050_2 of the pre-chamber 1050) can have a constriction (e.g. designed as a sealing edge) E, which defines a separation line (tear-off line) for the plastic of the plastic component.

The first and second boundaries 1050_1, 1050_2 can each represent kinks in the course of the sealing gap S. The transition 840_1 from the sealing gap S into the sealing cavity 840 can also be realized by a kink.

In all examples, the shape and dimensions of the sealing gap S can be chosen such that the sealing plastic 960 does not penetrate as far as the injection molding cavity 810. This prevents an optical defect from occurring on the plastic component 120.

This means that in all variants (FIGS. 10A to 10C), the low-viscosity plastic of the plastic component 120 in the plastic state can, for example, enter the sealing gap S over a certain distance and then be stopped by the sealing plastic 960 in the sealing gap S (e.g. within the pre-chamber 1050—see FIG. 10C—or in section A1). The (e.g. higher viscosity) sealing plastic 960 is already present in the sealing cavity 840 at the time of filling the injection molding cavity 810 and may already have cooled down at this time.

A burr can remain on the plastic component 120, which is formed by the sealing gap S. In the variants of FIGS. 10A and 10C, this burr at the sealing edge (constriction E) is realized as thinly (thickness of the burr in vertical dimension) and narrowly (width of the burr in horizontal dimension) as possible (i.e. is in theory not present at a gap width of 0). Furthermore, a burr-free separation can be realized, i.e. the burr is only present on the plastic component 120 during the injection molding process, since it remains directly on the plastic component 120 on the sealing plastic 960 due to the targeted tearing off of the burr, so that the finished plastic molded part 100 can be produced burr-free, for example.

In the variant shown in FIG. 10B, the tear-off line is moved to a different location at a distance A. This leaves a (defined) burr on the plastic component 120.

In the variants shown here, in which the two sealing surfaces F1, F2 are oriented at an angle to each other, a “cutting-against-sealing surface pairing” is created. Due to the linear cutting edge, the burr generation and thus the burr handling in the injection molding tool 600 can be performed in a more defined manner. This increases process reliability, e.g. by preventing uncontrolled burr breakage or burr forming.

In FIGS. 10A and 10C, the constriction point E is directly adjacent to the injection molding cavity 810 (i.e., at the entrance of the sealing gap S) and in FIG. 10B at the exit of the sealing gap S, but it can also be provided in the middle area of the sealing gap S (FIG. 10B). A cutting-against-cutting pairing (not shown) with a defined cutting edge line (constriction E) on opposite cutting edges is also possible.

For example, the burr at the constriction E can have a maximum thickness of 0.001 mm, 0.01 mm to 0.05 mm. Its width can be between 0.05 mm and 1 mm, for example. In FIG. 10C, the burr width can be from 0.05 mm to 3 mm or more, depending on the size of the pre-chamber 1050 and the degree of partial filling with plastic.

Accordingly, a distance A measured along the sealing gap S between the injection molding cavity 810 and the sealing cavity 840 can be between 0.05 mm and 1 mm, in particular between 0.1 mm or 0.2 mm and 0.4 mm or 0.5 mm. The pre-chamber 1050 can also border directly on the constriction E. The distance between the constriction E and the second boundary 1050_2 can thus be 0 mm and the section A2 would be omitted. The further constriction at the first boundary 1050_1 can also form the transition 840_1, which would eliminate section A1.

According to FIG. 11, in the example shown in FIG. 10C, the supply of the sealing plastic 960 to the pre-chamber 1050 can, for example, be in the form of a comb. In other words, the section A1 of the sealing gap S can be realized as a multi-channel system in the form of several individual connecting channels arranged next to each other, all of which open into the pre-chamber 1050. In this case, the connecting line in plan view between the plastic of the plastic component 120 (e.g. PUR) and the sealing plastic 960 is formed, e.g. in the form of a wavy line 1110, or, if the plastic of the plastic component fills the pre-chamber 1050 up to the pre-chamber edge 1050_1, in the form of a comb line not shown. Here, the dashed line 1120 denotes the outer wall of the base molded part 140 and the line 1130 denotes the outer surface of the plastic component 120 (i.e. the surface of the plastic molded part 100). The lines 1150_1 and 1150_2 correspond to the boundaries 1050_1 and 1050_2 of the pre-chamber 1050 in the transition to the first section A1 and the second section A2 of the sealing gap S, respectively. The line 1140_1 corresponds to the transition 840_1 from the sealing cavity 840 into the sealing gap S. The plastic webs 130 associated with the plurality of connecting channels are identified by the reference sign 1160.

The connecting channels can be made narrow (e.g. 0.2 mm) but deep (e.g. 0.5 mm) and thus improve the statics in section A1.

However, this wavy line 1110 or comb line, caused by the multi-channel design of the first section A1 of the sealing gap S, is not mandatory. It is also possible that the sealing plastic 960 is fed to the pre-chamber 1050 via a single slit-shaped first section A1 of the sealing gap S, which extends along the pre-chamber 840 and possibly over the entire circumference of the plastic molded part 100.

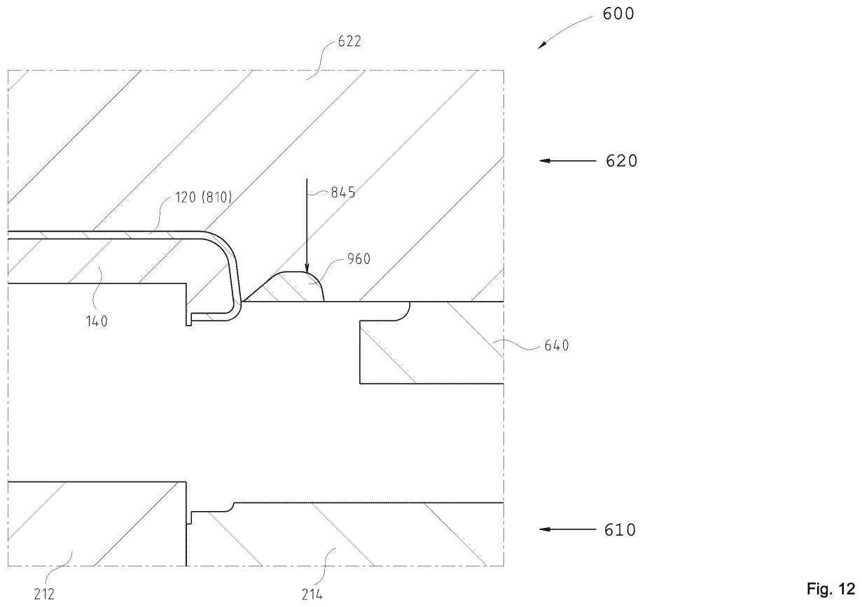

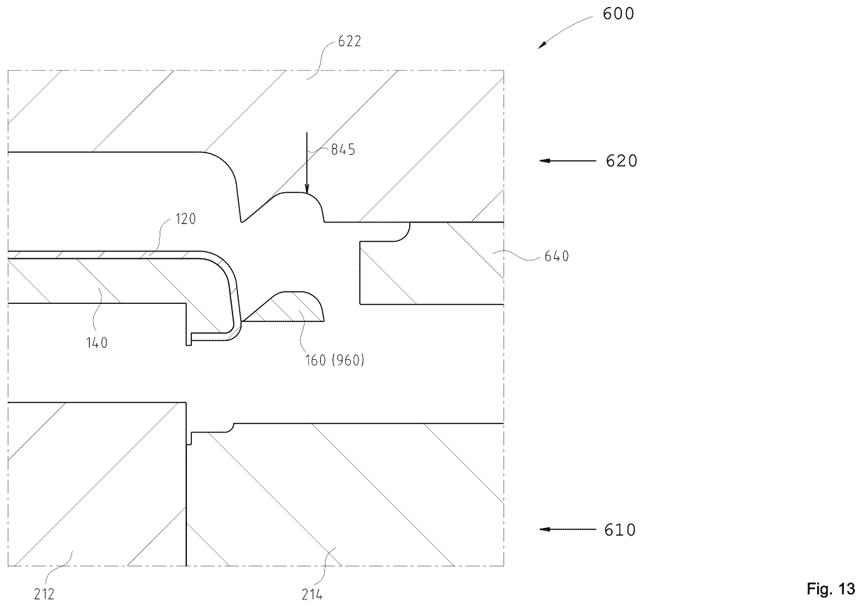

FIGS. 12 and 13 show in an exemplary manner (using the examples of FIGS. 10A and 10B) the opening of the injection molding tool 600. The slide 640 is retracted from its end position. The plastic molded part 100 can then be removed (demolding). The plastic molded part 100 comprises the plastic component 120, the optional base molded part 140 and, if applicable, the seal 160 formed by the sealing plastic 960.

The seal 160 can then be removed from the plastic molded part 100.

It is also possible that the seal 160 (sealing plastic 960) is separated (e.g. torn off) from the plastic molded part 100 before or during removal (demolding). This can occur, for example, by shrinkage of the plastic molded part 100 in the molding tool or by mechanical tearing during demolding.

According to an example, the seal 160 can remain in the sealing cavity 840. In this case, the seal 160 can be used several times if appropriate. In other words, when producing a further plastic molded part 100, the described method can be carried out again after the previously produced plastic molded part 100 has been removed, but instead of filling the sealing cavity 840, the seal 160 (sealing plastic 960) remaining in the sealing cavity 840 is used as a seal in the manufacturing of the further plastic molded part.

The seal 160 can be reused in subsequent injection molding cycles until the tightness of the sealing gap S is no longer guaranteed. The reused seal 160 is then removed and a new seal 160 is produced for the next injection molding cycle by filling the sealing cavity 840 with sealing plastic 960.

### EXAMPLES

The following examples pertain to further aspects of the disclosure:

Example 1 is an injection molding tool for manufacturing a plastic molded part having at least a plastic component, wherein the injection molding tool comprises: an injection molding cavity for producing the plastic component; a sealing gap of the injection molding cavity formed between two opposing sealing surfaces of the injection molding tool; and a sealing cavity into which the sealing gap opens on its side facing away from the injection molding cavity and which is configured to be filled with a sealing plastic for sealing the injection molding cavity. In addition, a pre-chamber may, e.g., be arranged in the sealing gap, which is shaped as a local expansion of the sealing gap.

In Example 2, the subject matter of Example 1 may optionally include at least one of the two sealing surfaces being provided on a mold plate comprising a contour surface of the injection molding cavity.

In Example 3, the subject matter of Example 1 or 2 may optionally include that at least one of the two sealing surfaces is provided on a slide, in particular a transverse or oblique slide, which comprises a contour surface of the injection molding cavity.

In Example 4, the subject matter of any of the preceding Examples may optionally include that at least one of the two sealing surfaces being provided on a sealing strip, in particular embossing frame.

In Example 5, the subject matter of any of the preceding Examples may optionally include that a distance measured along the sealing gap between the injection molding cavity and the pre-chamber (or, in the absence of a pre-chamber, the sealing cavity) is in the range between 0.05 mm and 1 mm, in particular between 0.2 mm and 0.5 mm.

In Example 6, the subject matter of any of the preceding Examples may optionally include that the sealing cavity has a cross-sectional height of between 2 mm and 7 mm, in particular 2 mm to 5 mm.

In Example 7, the subject matter of any of the preceding Examples may optionally include the sealing cavity partially or completely surrounding the injection molding cavity in a tubular shape.

In Example 8, the subject matter of any of the preceding Examples may optionally further comprise a plastic feed in communication with the sealing cavity.

In Example 9, the subject matter of any of the preceding Examples may optionally include that the sealing gap is formed by a cutting-against-sealing surface pairing or a cutting-against-cutting pairing or a pairing of two parallel sealing surfaces.

In Example 10, the subject matter of any of the preceding Examples may optionally include the sealing gap comprising a tightness that would seal the injection molding cavity when filled with polycarbonate.

In Example 11, the subject matter of any of the preceding Examples may optionally include the sealing gap comprising a tightness that does not seal the injection molding cavity when filled with polyurethane.

In Example 12, the subject matter of any of the preceding Examples may optionally include the sealing gap tapering from the injection molding cavity to the sealing cavity (or pre-chamber).

In Example 13, the subject matter of any one of Examples 1 to 11 may optionally include the sealing gap tapering from the sealing cavity (or pre-chamber) to the injection molding cavity.

In Example 14, the subject matter of one of the preceding Examples may optionally include that the injection molding cavity has a flat or planar configuration with an edge bending of more than 90° and the sealing gap of the injection molding cavity is arranged at or before the apex of the edge bending.

In Example 15, the subject matter of any of the preceding Examples may optionally include the plastic molded part comprising a base molded part and the plastic component, wherein the injection molding cavity is configured such that the plastic component forms a surface coating of the base molded part.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

1. An injection molding tool for manufacturing a plastic molded part comprising at least a plastic component, the injection molding tool comprising:
an injection molding cavity for producing the plastic component;
a sealing gap of the injection molding cavity formed between opposing sealing surfaces of the injection molding tool; and
a sealing cavity into which the sealing gap opens on a side of the sealing gap facing away from the injection molding cavity and which is configured to be filled with a sealing plastic to seal the injection molding cavity.

2. The injection molding tool of claim 1, further comprising a plastic feed connected to the sealing cavity.

3. The injection molding tool of claim 1, wherein the sealing gap comprises a cutting-against-cutting pairing or a cutting-against-sealing surface pairing or a pairing of two parallel sealing surfaces.

4. The injection molding tool of claim 1, wherein the sealing gap tapers from the injection molding cavity to the sealing cavity or wherein the sealing gap tapers from the sealing cavity to the injection molding cavity.

5. The injection molding tool of claim 1, further comprising:
a pre-chamber arranged in the sealing gap, which is shaped as a local expansion of the sealing gap.

6. The injection molding tool of claim 5, wherein a first section of the sealing gap between the pre-chamber and the sealing cavity is configured to provide a partial filling of the pre-chamber with the sealing plastic when filling the sealing cavity with the sealing plastic.

7. The injection molding tool of claim 5, wherein a second section of the sealing gap between the injection molding cavity and the pre-chamber has a constriction defining a separating line for plastic of the plastic component.

8. The injection molding tool of claim 7, wherein the constriction is formed by a tapering of the second section of the sealing gap by a cutting-against-cutting pairing or a cutting-against-sealing surface pairing.

9. The injection molding tool of claim 1, wherein the plastic molded part comprises a base molded part and the plastic component, wherein the injection molding cavity is designed such that the plastic component forms a surface coating of the base molded part.

10. A method of manufacturing a plastic molded part comprising at least a plastic component, the method comprising:
forming an injection molding cavity provided for manufacturing of the plastic component and a sealing gap of the injection molding cavity formed between opposing sealing surfaces of an injection molding tool, wherein the sealing gap opens into a sealing cavity on a side of the sealing gap facing away from the injection molding cavity;
filling the sealing cavity with a sealing plastic to seal the sealing gap; and
filling the injection molding cavity with the plastic component.

11. The method of claim 10, wherein a viscosity of the plastic component in a plastic state is so low that the plastic component would escape through the sealing gap into the sealing cavity if the sealing cavity were not filled.

12. The method of claim 10, wherein a viscosity of the sealing plastic in a plastic state is so high that the sealing plastic does not pass from the sealing cavity through the sealing gap into the injection molding cavity.

13. The method of claim 10, wherein the plastic molded part comprises a base molded part and the plastic component, wherein by filling the injection molding cavity the plastic component is injected onto the base molded part as a surface coating of the base molded part.

14. The method of claim 10, further comprising manufacturing a further plastic molded part, the method comprising:
removing the plastic molded part from the injection molding cavity; then
carrying out the method of claim 10 again to produce the further plastic molded part, wherein, however, instead of filling the sealing cavity, a seal formed by the sealing plastic during the manufacturing of the plastic molded part is left in the sealing cavity and used as a seal in the manufacturing of the further plastic molded part.

15. The method of claim 10, wherein a viscosity of the sealing plastic in a plastic state is greater than a viscosity of the plastic component in the plastic state.

16. A method of manufacturing a plastic molded part comprising at least a plastic component, the method comprising:
forming an injection molding cavity provided for the manufacturing of the plastic component and a sealing gap of the injection molding cavity formed between opposing sealing surfaces of the injection molding tool, wherein the sealing gap opens into a sealing cavity on a side of the sealing gap facing away from the injection molding cavity and a pre-chamber is arranged in the sealing gap, the pre-chamber being shaped as a local expansion of the sealing gap;
filling the sealing cavity with a sealing plastic; and
filling the injection molding cavity with plastic of the plastic component, whereby the pre-chamber is at least partially filled with the plastic of the plastic component.

17. The method of claim 16, wherein the pre-chamber is partially filled with the sealing plastic during filling of the sealing cavity.

18. The method of claim 16, wherein a viscosity of the sealing plastic in a plastic state is so high that the sealing plastic from the sealing cavity does not reach a second section of the sealing gap between the pre-chamber and the injection molding cavity.

19. The method of claim 16, wherein the plastic molded part comprises a base molded part and the plastic component, wherein by filling the injection molding cavity the plastic component is injected onto the base molded part as a surface coating of the base molded part.

20. The method of claim 16, further comprising:
tearing off a seal containing the sealing plastic from the plastic molded part at a separating line located in a second section of the sealing gap between the pre-chamber and the injection molding cavity.
